(19) United States
(12) Patent Application Publication
(10) Pub. No.: US 2026/0369715 A1
(43) Pub. Date: Nov. 19, 2026

(54) METHOD FOR RECOVERING VALUABLE METALS FOR LITHIUM SECOND BATTERY

(71) Applicant: SK On Co., Ltd., Seoul (KR)

(72) Inventors: Byoung Ki SON, Daejeon (KR); Chan Ho KIM, Daejeon (KR); Hyung Joo NOH, Daejeon (KR)

(21) Appl. No.: 19/645,296

(22) Filed: Apr. 13, 2026

(30) Foreign Application Priority Data
May 19, 2025 (KR) 10-2025-0064549

(51) Int. Cl. H01M 10/54; C22B 3/00; C22B 3/44; C22B 7/00; C22B 47/00; H01M 10/052

(52) U.S. Cl. CPC H01M 10/54; C22B 3/44; C22B 7/007; C22B 23/0415; C22B 47/00; H01M 10/052

(57) ABSTRACT

The method for recovering valuable metals for a lithium secondary battery is disclosed. In some implementations, the method for recovering valuable metals for a lithium secondary battery may include: a leachate preparation operation of mixing a raw material including valuable metals and impurities with an acidic solution; a first impurity removal operation of adding a basic solution to the leachate to precipitate the impurities; a metal complex formation operation of adding a complexing agent to the leachate after the first impurity removal operation to form a complex containing the valuable metals; and a second impurity removal operation of further adding a basic solution to the leachate after the metal complex formation operation to precipitate the remaining impurities.

### CROSS-REFERENCE TO RELATED APPLICATIONS

This patent document claims the priority and benefits of Korean Patent Application No. 10-2025-0064549 filed on May 19, 2025, the disclosure of which is incorporated herein by reference in its entirety.

### TECHNICAL FIELD

The disclosure and implementations disclosed in this patent document generally relate to a method for recovering valuable metals for a lithium secondary battery.

### BACKGROUND

Due to active research into electric vehicles (EVs) as an alternative to fossil fuel-based vehicles, which are one of the main causes of air pollution, a lithium secondary battery having high discharge voltage and stable output has mainly been used as a power source for such electric vehicles (EVs).

The valuable metals used in the lithium secondary battery may be recovered by removing impurities from raw materials containing the valuable metals. In this regard, as demand for a high-capacity and high-performance lithium secondary battery has increased recently, it is also important to recover valuable metals for a lithium secondary battery. Therefore, there is a need for an effective and economical method of recovering valuable metals for a lithium secondary battery.

### SUMMARY

The present disclosure can be implemented in some embodiments to provide a method for recovering valuable metals for a lithium secondary battery.

The present disclosure can be implemented in some embodiments to provide a method for recovering valuable metals for a lithium secondary battery with excellent economic efficiency.

In some embodiments of the present disclosure, a method for recovering valuable metals for a lithium secondary battery according to an embodiment of the present disclosure may include: a leachate preparation operation of mixing a raw material including valuable metals and impurities with an acidic solution; a first impurity removal operation of adding a basic solution to the leachate to precipitate the impurities; a metal complex formation operation of adding a complexing agent to the leachate after the first impurity removal operation to form a complex containing the valuable metal; and a second impurity removal operation of further adding a basic solution to the leachate after the metal complex formation operation to precipitate the remaining impurities.

The valuable metals may include at least one selected from the group consisting of Ni, Co and Mn.

The impurity may be a metallic impurity including at least one selected from the group consisting of Al, Cu, Fe, Mg, Na, Si, Ca, Zn, Cr, K, Cd, Pb, and Li.

The raw material may include at least one selected from the group consisting of a mixed hydroxide precipitate (MHP) containing metal, a metal composite precipitate (MCP), waste batteries, and cathode scrap.

The acidic solution may include at least one selected from the group consisting of hydrochloric acid, sulfuric acid and nitric acid.

The pH of the leachate prepared in the leachate preparation operation may be 0.1 to 1.

The basic solution may include at least one selected from the group consisting of NaOH, KOH, and Ca(OH)₂.

The pH of the leachate after the first impurity removal operation may be in a range of 3 to 4.

The complexing agent may provide ammonia (NH₃).

The complexing agent may include at least one selected from the group consisting of an aqueous ammonia solution, NH₃, (NH₄)₂SO₄, NH₄I, (NH₄)₃PO₄, NH₄C₂H₃O₂, (NH₄)₂C₂O₄, (NH₄)₂SO₃ and NH₄HCO₃.

In some embodiments of the present disclosure, the method for recovering valuable metals for a lithium secondary battery may include adding the complexing agent such that the ratio of the molar concentration of the ammonium ions to a sum of the molar concentrations of the valuable metal ions in the leachate is 1 to 4.

The temperature at which the complexing agent is added in the metal complex formation operation may be in a range of 20 °C to 80 °C.

The pH of the leachate after the second impurity removal operation may be in a range of 5 to 6.

According to an embodiment of the present disclosure, impurities contained in a raw material containing valuable metals may be effectively removed and thus valuable metals for a lithium secondary battery may be recovered.

According to an embodiment of the present disclosure, valuable metals for a lithium secondary battery included in the raw material may be recovered with minimal loss.

### BRIEF DESCRIPTION OF THE DRAWINGS

Certain aspects, features, and advantages of the present disclosure are illustrated by the following detailed description with reference to the accompanying drawings.

FIG. 1 is a flowchart of a method for recovering valuable metals for a lithium secondary battery according to an embodiment of the present disclosure.

### DETAILED DESCRIPTION

Features of the present disclosure disclosed in this patent document are described by example embodiments with reference to the accompanying drawings. However, the embodiment of the technology may be modified into various other forms, and its scope is not limited to the embodiments described below. Only specific examples of implementations of certain embodiments are described. Variations, improvements and enhancements of the disclosed embodiments and other embodiments may be made based on the disclosure of this patent document.

As described above, there is a need for an effective and economical method for recovering valuable metals for a lithium secondary battery. According to one embodiment, in order to recover nickel (Ni), cobalt (Co) and manganese (Mn), which are valuable metals, from the raw material, the raw material may be mixed with an acidic solution such as an aqueous solution of sulfuric acid and then leached, followed by selectively extracting the valuable metals using a solvent extraction process. In this case, when the solvent extraction process is used, the valuable metals may be recovered in the form of a solid salt such as sulfate. However, the solvent extraction process has complicated operations and high costs for extraction solvents, so it may not be economically feasible.

According to another embodiment, the valuable metals may be recovered by leaching a raw material with an acidic solution and then adding a basic solution to precipitate impurities other than the valuable metal. When a basic solution is added to the leachate, i.e. leaching solution, impurity metal ions are precipitated as the pH increases, and the valuable metals can be recovered from the leachate in which the impurity metal ions have been removed. At this time, the impurity metal ions react with OH− as the pH increases and thus precipitate. However, if the pH of the leachate increases to a certain level or higher (e.g., about 3.5 or higher), the valuable metals such as Ni, Co, and Mn also start reacting with OH− and precipitating. As a result, the loss of the valuable metals becomes large and the recovery rate of the valuable metals decreases.

The present disclosure can be implemented in some embodiments to provide the method for recovering valuable metals for a lithium secondary battery including the operations of: leaching a raw material in an acidic solution; increasing the pH of the leachate by adding a basic solution; and adding a complexing agent. As the complexing agent is added, valuable metal ions combine with the complexing agent to form a metal complex, so that the pH at which the valuable metal ions are precipitated by reaction with OH− can be significantly increased. Therefore, even if the pH of the leachate is further increased to additionally remove impurities, loss caused by precipitation of the valuable metals can be minimized, thereby effectively recovering the valuable metals.

The present disclosure can be implemented in some embodiments to provide the method for recovering valuable metals for a lithium secondary battery according to an embodiment of the present disclosure including: a leachate preparation operation of mixing a raw material including valuable metals and impurities with an acidic solution; a first impurity removal operation of adding a basic solution to the leachate to precipitate the impurities; a metal complex formation operation of adding a complexing agent to the leachate after the first impurity removal operation to form a complex, that is a metal complex, containing the valuable metals; and a second impurity removal operation of further adding a basic solution to the leachate after the metal complex formation operation to precipitate the remaining impurities.

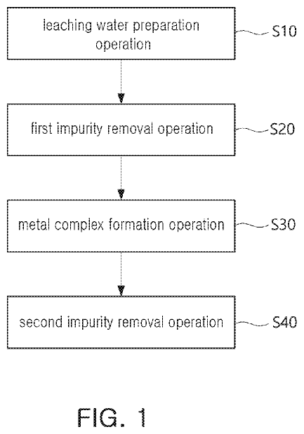

FIG. 1 is a flowchart of a method for recovering valuable metals for a lithium secondary battery according to an embodiment of the present disclosure. Referring to FIG. 1, the method for recovering valuable metals for a lithium secondary battery according to the present disclosure will be described in more detail below.

### Leachate Preparation Operation.

The method for recovering valuable metals for a lithium secondary battery according to the present disclosure may include a leachate preparation operation (S10) of leaching a raw material that includes valuable metals and impurities in an acidic solution.

The valuable metals refer to metallic materials that may be included in a lithium secondary battery, and are not limited to any particular location of use as long as they are used in manufacturing of the lithium secondary battery. For example, the valuable metals may refer to a metal included in an active material of a positive electrode and/or negative electrode of the lithium secondary battery. More specifically, the valuable metals may include at least one selected from the group consisting of Ni, Co and Mn. Ni, Co and Mn may be included in the positive electrode active material of the lithium secondary battery in the form of a lithium metal oxide. For example, as the positive electrode active material of the lithium secondary battery, an NCM-based positive electrode active material including Ni, Co and Mn may be used. In particular, Ni may be a transition metal associated with the output and capacity of the lithium secondary battery. Accordingly, if loss of valuable metals such as Ni, Co and Mn from the raw material is minimized during recovery, the productivity of the process for manufacturing the lithium secondary battery may be increased.

The impurity refers to a material other than the valuable metals included in the raw material and is not limited to a specific material. For example, when recovering Ni, Co, and Mn as valuable metals for a lithium secondary battery from the raw material, the impurity may be a material other than Ni, Co, and Mn. More specifically, the impurity may be a metallic impurity including at least one selected from the group consisting of Al, Cu, Fe, Mg, Na, Si, Ca, Zn, Cr, K, Cd, Pb, and Li.

The raw material includes valuable metals for a lithium secondary battery and is not limited as long as the valuable metals may be recovered. Specifically, the raw material may include at least one selected from the group consisting of a mixed hydroxide precipitate (MHP) containing metal, a metal composite precipitate (MCP), waste batteries, and cathode scrap. In particular, when the raw material is a waste battery or cathode scrap, it is environmentally friendly as well as economical because used valuable metals can be recovered and reused. The raw material may be mixed in powder form with an acidic solution.

The acidic solution is not limited to a specific solution as long as it can leach the valuable metals in the raw material into metal ions. For example, the acidic solution may include at least one selected from the group consisting of hydrochloric acid, sulfuric acid and nitric acid. More specifically, the acidic solution may be sulfuric acid. When using strong acidic solutions such as hydrochloric acid, sulfuric acid and nitric acid, the valuable metals included in the raw material can be sufficiently leached into metal ions.

The pH of the leachate prepared in the leachate preparation operation (S10) may be 0.1 to 1. For example, the pH of the prepared leachate may be greater than or equal to 0.1 and less than or equal to 1, 0.9, 0.8, 0.7, 0.6, or 0.5. When the pH of the prepared leachate exceeds 1, valuable metals and impurities contained in the raw material are not sufficiently leached into the leachate as metal ions, thereby reducing a recovery rate of valuable metals. When the pH of the prepared leachate is less than 0.1, the amount of basic solution added in a subsequent impurity removal operation increases, so that concentration of metal ions introduced from the basic solution increases in the leachate.

As described above, the leachate produced in the leachate preparation operation (S10) may include metal ions of valuable metals and impurities. Also, the leachate may contain anions included in the acidic solution. For example, when a sulfuric acid solution is used as the acidic solution, sulfate ions (SO₄²⁻) included in the sulfuric acid solution may be present in the leachate.

### First Impurity Removal Operation.

The method for recovering valuable metals according to the present disclosure may include a first impurity removal operation (S20) of adding a basic solution to the leachate to precipitate impurities.

In the leachate preparation operation (S10), the valuable metals and impurities are present in the leachate as metal ions. As described above, when a basic solution is added, the pH of the leachate increases, so that the metal ions may react with OH⁻ to precipitate as M(OH)ₓ (where M is a metal). The metal ions of the valuable metals and impurities may have different pH values at which precipitation starts. For example, Ni, Co and Mn among the valuable metals for a lithium secondary battery may start precipitating as M(OH)ₓ at about pH 3.5 or higher. In this case, M may be Ni, Co or Mn, and x may be an integer of 1 to 3, for example 2. Therefore, in the first impurity removal operation (S20), the pH may be increased up to a value equal to or lower than the pH at which the metal ions of the valuable metals start precipitating, thereby allowing impurities other than the valuable metals to precipitate.

The basic solution is not limited to a specific solution as long as it can provide OH− and precipitate impurities present in the leachate. For example, the basic solution may include at least one selected from the group consisting of NaOH, KOH, and Ca(OH)₂. More specifically, the basic solution may include NaOH or KOH. When using a strong basic solution such as NaOH, KOH, and Ca(OH)₂, impurities contained in the leachate can be effectively precipitated.

The pH of the leachate after the first impurity removal operation (S20) may be a pH value at which precipitation of the valuable metals starts. The pH value at which precipitation starts as defined in this disclosure does not mean that no precipitation occurs below the pH value, but means that when the pH is equal to or higher than the pH value, the rate at which metal ions react with OH⁻ and precipitate in the form of M(OH)ₓ becomes rapidly increased. More specifically, the pH of the leachate after the first impurity removal operation (S20) may be in a range of 3 to 4. For example, the pH of the leachate after the first impurity removal operation (S20) may be 3.1 to 3.9, 3.2 to 3.8, 3.3 to 3.7, or 3.4 to 3.6. When the valuable metals are Ni, Co and Mn, the pH at which precipitation of Ni, Co and Mn starts may be about 3.5. Therefore, if the pH of the leachate after the first impurity removal operation (S20) exceeds 4, the valuable metals precipitate in large amounts during the first impurity removal operation (S20), thereby reducing recovery yield of the valuable metals. On the other hand, if the pH of the leachate after the first impurity removal operation (S20) is less than 3, impurities to be precipitated may not be sufficiently precipitated during the first impurity removal operation (S20).

The impurities precipitated in the first impurity removal operation (S20) are not limited and may include metals having a lower precipitation start pH than that of the valuable metal. For example, as the pH increases in the first impurity removal operation (S20), Cu, Zn, and Cd among the impurities may be precipitated at a pH range about 0.1 to 1. As the pH increases in the first impurity removal operation (S20), Al, Fe, Cr, Si, Ca, and Mg among the impurities may be precipitated at a pH range about 0.1 to 3.5.

### Metal Complex Formation Operation.

The method for recovering valuable metals according to the present disclosure may include a metal complex formation operation (S30) in which a complexing agent is added to the leachate after the first impurity removal operation (S20), thereby forming a metal complex containing the valuable metals.

In the first impurity removal operation (S20), since the pH of the leachate is controlled not to exceed a pH at which valuable metals start to precipitate, only a small amount of valuable metals precipitate. At this time, when a complexing agent is added to the leachate, the complexing agent and the valuable metal ions may form a metal complex by coordination bonding. When the valuable metals form a metal complex, it can significantly increase a pH at which precipitation starts. Therefore, even if the pH of the leachate increases to precipitate residual impurities in the second impurity removal operation (S40) described below, precipitation of valuable metals can be minimized. Specifically, when the valuable metals are transition metals such as Ni, Co and Mn, they easily combine with the complexing agent to form complexes, so that precipitation of Ni, Co and Mn can be minimized. Although not being bound by any particular theory, according to orbital theory, Ni, Co and Mn ions have relatively unstable outermost electron configurations, and thus can be stabilized by forming coordination bonds with the complexing agent. As the valuable metals form complexes with the complexing agent, the concentration of the valuable metal ions presents in the leachate decreases, thereby increasing the pH at which the valuable metals start to precipitate.

The complexing agent is not limited as long as it can combine with the valuable metal ions to form a metal complex. For example, the complexing agent may provide ammonia (NH₃). When the complexing agent provides NH₃, the valuable metals and NH₃ may coordinate to form a metal complex in the form of M[(NH₃)ₓ]²⁺ (where M represents valuable metal). More specifically, the complexing agent may include at least one selected from the group consisting of an aqueous ammonia solution, NH₃, (NH₄)₂SO₄, NH₄I, (NH₄)₃PO₄, NH₄C₂H₃O₂, (NH₄)₂C₂O₄, (NH₄)₂SO₃ and NH₄HCO₃.

When the complexing agent provides NH₃, the complexing agent may be added such that the ratio of the molar concentration of ammonium ions (NH₄⁺) to a sum of molar concentrations of valuable metal ions in the leachate is 1 to 4. For example, the complexing agent may be added such that the ratio of the molar concentration of ammonium ions to a sum of molar concentrations of valuable metal ions in the leachate is 1.5 to 4, 2 to 4, or 1.5 to 2.5. More specifically, when the valuable metals are Ni, Co and Mn, the ratio of the molar concentration of ammonium ions to the sum of molar concentrations of Ni, Co and Mn ions in the leachate, i.e., molar concentration of NH₄⁺/NCM molar concentration, may be 1 to 4, 1.5 to 4, 2 to 4 or 1.5 to 2.5.

When the complexing agent is added such that a ratio of molar concentration of ammonium ions to the sum of molar concentrations of valuable metal ions is less than 1, the formation of metal complexes of the valuable metal may not be sufficiently performed, and thus a large amount of valuable metals may precipitate in the second impurity removal operation (S40) described below. When the complexing agent is added such that the ratio of molar concentration of ammonium ions to the sum of molar concentrations of valuable metal ions exceeds 4, the complexing agent may form metal complexes in large amounts not only with the valuable metals in the leachate but also with impurity metal ions, so that precipitation of impurities may not proceed well in the second impurity removal operation (S40) described below.

The temperature at which the complexing agent is added in the metal complex formation operation (S30) may be in a range of 20 °C to 80 °C. For example, the temperature at which the complexing agent is added in the metal complex formation operation (S30) may be higher than or equal to 25 °C, 35 °C, 45 °C, or 55 °C and lower than or equal to 80 °C, 75 °C, 70 °C, 65 °C, or 60 °C. When the complexing agent is added at a temperature within this range, it is possible to bind the complexing agent with the valuable metal ions and minimize precipitation of the valuable metal ions relatively well.

When the valuable metals are Ni, Co and Mn, since a metal complex is formed as described above, the pH at which precipitation starts may increase to about 4.5 or higher. Therefore, in the second impurity removal operation (S40), even when the pH is increased to a predetermined value, it is possible to minimize precipitation of the valuable metals compared with a case where no complexing agent is added.

### Second Impurity Removal Operation.

The method for recovering valuable metals according to the present disclosure may include a second impurity removal operation (S40) in which a basic solution is further added to the leachate having passed through the metal complex formation operation (S30) to precipitate remaining impurities.

The leachate obtained after passing through the metal complex formation operation (S30) may contain residual impurities that were not removed in the first impurity removal operation (S20) in the form of metal ions. In the leachate subjected to the metal complex formation operation (S30), the valuable metals are bonded to the complexing agent, and thus precipitation of valuable metals may be minimized even when the pH is increased to precipitate the residual impurities.

The second impurity removal operation may be performed by adding a basic solution to the leachate to increase the pH thereof and thereby allowing metal ions to react with OH− to precipitate impurities in the form of M(OH)x (M is a metal). The basic solution may be the same as that used in the first impurity removal operation (S20).

The pH of the leachate after the second impurity removal operation (S40) may be a pH value at which residual impurities are sufficiently precipitated. For example, the pH of the leachate after the second impurity removal operation (S40) may be in a range of 5 to 6. More specifically, the pH of the leachate after the second impurity removal operation (S40) may be in a range of 5.1 to 5.9, 5.2 to 5.8, 5.3 to 5.7 or 5.4 to 5.6. When the pH of the leachate after the second impurity removal operation (S40) is less than 5, residual impurities present in the leachate may not be sufficiently removed. When the pH of the leachate after the second impurity removal operation (S40) exceeds 6, precipitation of valuable metals may also increase, and thus recovery of valuable metals may decrease, making it difficult to secure economic efficiency.

The impurities precipitated in the second impurity removal operation (S40) are not limited and may be residual impurities that were not precipitated in the first impurity removal operation (S20). As described above, because the valuable metals form metal complexes during the metal complex formation operation (S30), the pH at which the valuable metals begin to precipitate is increased, so precipitation caused by an increase in pH in the second impurity removal operation can be minimized.

As described above, the leachate obtained by passing through the leachate preparation operation (S10), the first impurity removal operation (S20), the metal complex formation operation (S30), and the second impurity removal operation (S40) according to the present disclosure may be in a state where impurities are effectively precipitated while minimizing loss of valuable metals.

Therefore, the leachate may be filtered to remove precipitated impurities. The leachate, from which the precipitated impurities have been removed, contains a large amount of valuable metals while minimizing loss of the valuable metals, and thus, by using the leachate as a raw material, precursors of cathode active materials for a lithium secondary battery can be manufactured, thereby effectively recovering the valuable metals.

### EMBODIMENTS

Hereinafter, embodiments of the present disclosure will be described in more detail with reference to specific examples. The Embodiments and Comparative Examples included in the experiments are merely illustrative of the present disclosure and do not limit the scope of the appended claims; it will be apparent to those skilled in the art that various modifications and changes may be made within the spirit and scope of the present disclosure, and that such modifications and variations are encompassed by the appended claims.

### Embodiment 1

### (1) Leachate Preparation.

The cathode scrap 100 g separated from the waste battery was powdered. The powdered cathode scrap was leached in an aqueous solution of sulfuric acid (H₂SO₄) at a concentration of 2 M to prepare leachate. At this time, the pH of the prepared leachate was 0.5. The concentrations of Ni, Co and Mn in the prepared leachate were measured using ICP-OES, and the sum thereof (hereinafter referred to as NCM molar concentration) was determined and is shown in Table 1 below.

### (2) First Impurity Removal.

In the leachate prepared in (1), an aqueous sodium hydroxide (NaOH) solution having a concentration of 8 M was added to increase the pH of the leachate to 3.5. The leachate was stirred at 25 °C and at a speed of 400 rpm for 60 minutes, and it was confirmed that solid metal ion precipitates were generated. Thereafter, the NCM molar concentration of the leachate was measured and is shown in Table 1 below.

### (3) Metal Complex Formation.

An aqueous ammonia solution (NH₃) having a concentration of 7.6 M was added to the leachate obtained in operation (2). The aqueous ammonia solution was added such that the molar concentration of NH₄⁺ in the leachate/the NCM molar concentration value becomes 1. The leachate was stirred at 25 °C at 400 rpm for 60 minutes, and the pH of the leachate was 3.8.

### (4) Second Impurity Removal.

An aqueous sodium hydroxide (NaOH) solution having a concentration of 8 M was added to the leachate obtained in operation (3) to increase the pH of the leachate to 5.5. The leachate was stirred at 25 °C and at a speed of 400 rpm for 60 minutes, and it was confirmed that solid metal ions precipitates were generated. Then, the NCM molar concentrations of the leachate was measured in operation (4), and the results of operations (1), (2), and (4) are shown in Table 1.

### Embodiment 2

In operation (3), leaching of valuable metals was performed in the same manner as Embodiment 1, except that an aqueous ammonia solution was added such that the molar concentration of NH₄⁺/the NCM molar concentration value, that is the molar ratio of NH₄⁺ to NCM, becomes 2, and the results are shown in Table 1.

### Embodiment 3

In operation (3), leaching of valuable metals was performed in the same manner as Embodiment 1 except that an aqueous ammonia solution was added such that the molar concentration of NH₄⁺/NCM value becomes 4, and the results are shown in Table 1.

### Embodiment 4

The leaching of valuable metals was performed in the same manner as Embodiment 1 except that operations (2) to (4) were carried out at a temperature of 45 °C, and the results are shown in Table 1.

### Embodiment 5

The leaching of valuable metals was performed in the same manner as Embodiment 1 except that operations (2) to (4) were carried out at a temperature of 60 °C, and the results are shown in Table 1.

### Comparative Example 1

The leaching of valuable metals was performed in the same manner as Embodiment 1 except that operation (3) above was not carried out.

### Comparative Example 2

The leaching of valuable metals was performed in the same manner as Comparative Example 1 except that operations (2) and (4) were carried out at a temperature of 45 °C, and the results are shown in Table 1.

### Comparative Example 3

The leaching of valuable metals was performed in the same manner as Comparative Example 1 except that operations (2) and (4) were carried out at a temperature of 60 °C, and the results are shown in Table 1.

### Comparative Example 4

In operations (2) and (4), leaching of valuable metals was performed in the same manner as Comparative Example 1 except that stirring was carried out at a stirring speed of 200 rpm, and the results are shown in Table 1.

### Comparative Example 5

In operations (2) and (4), leaching of valuable metals was performed in the same manner as Comparative Example 1 except that stirring was carried out at a stirring speed of 800 rpm, and the results are shown in Table 1.

### Comparative Example 6

In operations (2) and (4), leaching of valuable metals was performed in the same manner as Comparative Example 1 except that stirring was carried out for 30 minutes, and the results are shown in Table 1.

### Comparative Example 7

In operations (2) and (4), leaching of valuable metals was performed in the same manner as Comparative Example 1 except that stirring was carried out for 120 minutes, and the molar concentrations (M, mol/L) obtained are shown in Table 1.

TABLE 1

| | | | | (pH 0.5 NCM |
|---|---|---|---|---|
| | | (2)pH 3.5 | (4)pH 5.5 | concentration − pH |
| | (1)pH 0.5 | NCM | NCM | 5.5 NCM |
| | NCM | concen- | concen- | concentration) × |
| | concen- | tration | tration | 100/pH 0.5 NCM |
| | tration(M) | (M) | (M) | concentration (%) |
| Embodiment 1 | 1.79 | 1.55 | 1.25 | 30.17 |
| Embodiment 2 | 1.81 | 1.57 | 1.46 | 19.34 |
| Embodiment 3 | 1.80 | 1.56 | 1.44 | 20.00 |
| Embodiment 4 | 1.80 | 1.54 | 1.46 | 18.89 |
| Embodiment 5 | 1.81 | 1.55 | 1.47 | 18.78 |
| Comparative | 1.80 | 1.54 | 1.03 | 42.78 |
| Example 1 | | | | |
| Comparative | 1.79 | 1.56 | 1.08 | 39.66 |
| Example 2 | | | | |
| Comparative | 1.79 | 1.58 | 1.09 | 39.11 |
| Example 3 | | | | |
| Comparative | 1.80 | 1.48 | 0.97 | 46.11 |
| Example 4 | | | | |
| Comparative | 1.81 | 1.55 | 1.08 | 40.33 |
| Example 5 | | | | |
| Comparative | 1.81 | 1.32 | 0.83 | 54.14 |
| Example 6 | | | | |
| Comparative | 1.79 | 1.56 | 1.07 | 40.22 |
| Example 7 | | | | |

Referring to Table 1 above, it can be seen that the NCM molar concentration of the leachate in operation (1) with a pH of 0.5 and the NCM molar concentration of the leachate at operation (2) with a pH of 3.5 are similar in Embodiments 1 to 5 and Comparative Examples 1 to 7.

However, in Embodiments 1 to 5, where an aqueous ammonia solution was introduced in operation (3), the NCM molar concentration in the leachate having a pH of 5.5 in operation (4) was found to be significantly higher than those in Comparative Examples 1 to 7. In addition, the loss rate of Ni, Co and Mn was calculated by the formula ((NCM molar concentration at pH 0.5−NCM molar concentration at pH 5.5)/(NCM molar concentration at pH 0.5))×100, which is shown in Table 1 above, and referring to this, in Embodiments 1 to 5, the loss rate of Ni, Co, and Mn in the leachate (hereinafter, NCM loss rate) was found to be significantly lower than those in Comparative Examples 1 to 7.

This indicates that in Embodiments 1 to 5, a metal complex is formed at operation (3) by coordination between ammonia, as the complexing agent, and the valuable metals Ni, Co and Mn which have high reactivity with the complexing agent, and accordingly the pH at which Ni, Co and Mn precipitate by reaction with OH− is increased. By contrast, in Comparative Examples 1 to 7, since operation (3) was not carried out and no complexing agent was added, the valuable metals Ni, Co and Mn remain in the form of metal ions and, at pH 3.5 or higher, a relatively large amount of the valuable metals precipitate by reacting with OH−.

Accordingly, it can be confirmed that a metal complex containing valuable metals may be formed by adding a complexing agent at a pH of about 3.5 at which Ni, Co and Mn, which are valuable metals of the lithium secondary battery, react with OH− in the leachate and start to precipitate. Furthermore, it can be confirmed that even if the pH is increased to 5.5 to additionally remove impurities, precipitation of Ni, Co and Mn in the leachate is prevented, thereby effectively removing impurities while minimizing loss of the valuable metals.

In addition, referring to Table 1, in Embodiments 1 to 5, it can be seen that there is a difference in the NCM loss rate according to the (molar concentration of NH₄⁺/NCM molar concentration) value. Specifically, in Embodiment 1, where an aqueous ammonia solution was added so that the (molar concentration of NH₄⁺/NCM molar concentration) value becomes 1, the NCM loss rate in the leachate was lower than in Comparative Examples 1 to 7, but the NCM loss rate in the leachate was higher than in Embodiments 2 to 5. This is because Ni, Co and Mn ions that did not form metal complexes due to an insufficient amount of the added aqueous ammonia solution precipitated in large amounts as the pH increased.

On the other hand, in Embodiment 3, where an aqueous ammonia solution was added so that (the molar concentration of NH₄⁺/NCM molar concentration) value becomes 4, it can be seen that the loss rate of NCM in the leachate is higher than those in Embodiments 2, 4 and 5 despite the larger amount of aqueous ammonia solution added. This is because the aqueous ammonia solution was added in excess compared to the amount capable of forming complexes with Ni, Co and Mn ions present in the leachate, so that additional addition of the aqueous ammonia solution did not further reduce the loss rate of NCM. Therefore, when the aqueous ammonia solution is added so that (the molar concentration of NH₄⁺/NCM molar concentration) value becomes about 2, metal complexes are sufficiently formed with Ni, Co and Mn ions present in the leachate to effectively recover valuable metals.

What is claimed is:

1. A method for recovering valuable metals for a lithium secondary battery comprising:
a leachate preparation operation of mixing a raw material including valuable metals and impurities with an acidic solution;
a first impurity removal operation of adding a basic solution to the leachate to precipitate the impurities;
a metal complex formation operation of adding a complexing agent to the leachate after the first impurity removal operation to form a complex containing the valuable metal; and
a second impurity removal operation of further adding a basic solution to the leachate after the metal complex formation operation to precipitate the remaining impurities.

2. The method for recovering valuable metals for a lithium secondary battery of claim 1, wherein the valuable metals comprise at least one selected from the group consisting of Ni, Co and Mn.

3. The method for recovering valuable metals for a lithium secondary battery of claim 1, wherein the impurity is a metallic impurity comprising at least one selected from the group consisting of Al, Cu, Fe, Mg, Na, Si, Ca, Zn, Cr, K, Cd, Pb, and Li.

4. The method for recovering valuable metals for a lithium secondary battery of claim 1, wherein the raw material comprises at least one selected from the group consisting of a mixed hydroxide precipitate (MHP) containing metal, a metal composite precipitate (MCP), waste batteries, and cathode scrap.

5. The method for recovering valuable metals for a lithium secondary battery of claim 1, wherein the acidic solution comprises at least one selected from the group consisting of hydrochloric acid, sulfuric acid and nitric acid.

6. The method for recovering valuable metals for a lithium secondary battery of claim 1, wherein the pH of the leachate prepared in the leachate preparation operation is 0.1 to 1.

7. The method for recovering valuable metals for a lithium secondary battery of claim 1, wherein the basic solution comprises at least one selected from the group consisting of NaOH, KOH, and Ca(OH)₂.

8. The method for recovering valuable metals for a lithium secondary battery of claim 1, wherein the pH of the leachate after the first impurity removal operation is in a range of 3 to 4.

9. The method for recovering valuable metals for a lithium secondary battery of claim 1, wherein the complexing agent provides ammonia (NH₃).

10. The method for recovering valuable metals for a lithium secondary battery of claim 1, wherein the complexing agent comprises at least one selected from the group consisting of an aqueous ammonia solution, NH₃, (NH₄)₂SO₄, NH₄I, (NH₄)₃PO₄, NH₄C₂H₃O₂, (NH₄)₂C₂O₄, (NH₄)₂SO₃ and NH₄HCO₃.

11. The method for recovering valuable metals for a lithium secondary battery of claim 9, wherein the complexing agent is added such that the ratio of the molar concentration of ammonium ions to a sum of molar concentrations of valuable metal ions in the leachate is 1 to 4.

12. The method for recovering valuable metals for a lithium secondary battery of claim 1, wherein the temperature at which the complexing agent is added in the metal complex formation operation in a range of 20 °C to 80 °C.

13. The method for recovering valuable metals for a lithium secondary battery of claim 1, wherein the pH of the leachate after the second impurity removal operation is in a range of 5 to 6.
